(19) United States
(12) Patent Application Publication
(10) Pub. No.: US 2026/0162424 A1
(43) Pub. Date: Jun. 11, 2026

(54) SELF-SUPERVISED OBJECT DETECTION SYSTEM FOR ROAD CRACK DETECTION USING AERIAL IMAGES

(71) Applicants: King Fahd University of Petroleum and Minerals, Dhahran (SA); SAUDI DATA AND ARTIFICIAL INTELLIGENCE AUTHORITY (SDAIA), Riyadh (SA)

(72) Inventors: Hussein Salem Ali BIN SAMMA, Dhahran (SA); Sadam Hussein Mohammed AL-AZANI, Dhahran (SA)

(73) Assignees: King Fahd University of Petroleum and Minerals, Dhahran (SA); SAUDI DATA AND ARTIFICIAL INTELLIGENCE AUTHORITY (SDAIA), Riyadh (SA)

(21) Appl. No.: 19/296,191

(22) Filed: Aug. 11, 2025

Related U.S. Application Data
(60) Provisional application No. 63/729,515, filed on Dec. 9, 2024.

(51) Int. Cl. G06V 20/17; G06T 5/50; G06V 10/774; G06V 10/82

(52) U.S. Cl. CPC G06V 20/17; G06T 5/50; G06V 10/7753; G06V 10/82

(57) ABSTRACT

A system and method are disclosed for detecting object instances in a plurality of target images using a contrastive loss-augmented object detection model. The method includes pre-training the object detection model on a synthetic training image set, the synthetic set generated by superimposing augmented foreground instances onto background images. The model is subsequently fine-tuned on a real training image set comprising annotated object instances. The trained model is applied to detect and annotate object instances, such as road surface damages including cracks and potholes, in target images. The synthetic pre-training incorporates a contrastive loss to improve intra-class compactness and inter-class separability of feature embeddings. An aggregate loss comprising classification, regression, objectness, and contrastive loss terms is used to update model parameters. The system may be deployed on aerial platforms such as unmanned aerial vehicles (UAVs), and utilizes a self-supervised YOLOv7-based architecture to achieve enhanced detection performance.

### CROSS REFERENCE TO RELATED APPLICATION

The present application claims benefit of priority to U.S. Provisional Application No. 63/729,515 having a filing date of Dec. 9, 2024, and which is incorporated herein by reference in its entirety.

### STATEMENT OF ACKNOWLEDGEMENT

Support provided by Saudi Data & AI Authority (SDAIA) and King Fahd University of Petroleum & Minerals (KFUPM) under SDAIA-KFUPM Joint Research Center for Artificial Intelligence (JRC-AI) grant No. JRCAI-RG-07 is gratefully acknowledged.

### BACKGROUND

### Technical Field

The present disclosure relates generally to the field of computer vision-based pavement inspection and more particularly to systems and methods for automated road crack detection using self-supervised object detection techniques applied to target images.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present disclosure.

Road pavement degradation is a widespread infrastructure challenge. Cracks such as longitudinal, transverse, oblique, alligator, and pothole formations deteriorate road quality and compromise safety. Traditionally, pavement condition assessments have relied on manual inspections, which are labor-intensive, subjective, and inefficient. While specialized inspection vehicles equipped with sensors and cameras improve reliability, they remain cost-prohibitive for widespread deployment.

Recent advances in computer vision and deep learning have enabled automated road damage detection systems. Object detection models are a class of algorithms designed to identify instances of predefined object categories within digital images by localizing them using bounding boxes. In the context of pavement evaluation, object detection models assist in identifying and classifying different types of cracks in road surfaces from images or video streams.

One of the object detection frameworks is You Only Look Once (YOLO), known for its high-speed, real-time detection capability. YOLO processes an entire image in a single forward pass, predicting object classes and bounding box coordinates simultaneously. Enhanced variants such as YOLOv3, YOLOv4, YOLOv5, and YOLOv7 have been introduced to improve detection accuracy, especially for small and irregularly shaped targets. These models typically comprise three stages. First, a backbone for feature extraction, second, a neck for feature aggregation (e.g., Feature Pyramid Networks), and third, a head for multi-scale detection.

Training object detection models typically requires large volumes of annotated data. Annotating complex road damage patterns is time-consuming and requires expert labeling, particularly for crack types that exhibit subtle visual variations. This data bottleneck poses a significant limitation in scaling and generalizing detection models for diverse environments.

To address the issue of limited labeled data, synthetic datasets have been utilized. For example, WO2024054815A1 describes a method for pavement condition monitoring using deep neural networks, including the creation of synthetic ground-penetrating radar (GPR) images. The method involves using unfeatured GPR images as backgrounds, superimposing smaller object features such as cracks, and generating augmented datasets via transformations such as resizing and normalization. The synthetic dataset is used to train a modified YOLOR model, which is validated on both synthetic and real images. Although effective for crack detection in GPR scans, the approach focuses primarily on subsurface feature localization and limited crack categories, such as bottom cracks and full cracks.

The concept of image augmentation and synthetic dataset generation is further extended in CN117437201A, which discloses a road crack detection method using an improved YOLOv7 model. The approach includes constructing a dataset through image filtering, labeling, and enhancement techniques such as random rotation, scaling, and brightness adjustment. The YOLOv7 architecture employed comprises ELAN modules in the backbone to preserve gradient flow and improve feature extraction, and it integrates MPDIoU as a novel bounding box regression loss function. However, the technique does not include contrastive learning or self-supervised training schemes.

In the context of model pretraining, self-supervised learning (SSL) has emerged as a data-efficient alternative to traditional supervised methods. SSL enables models to learn feature representations from unlabeled data through proxy tasks, such as image jigsaw, colorization, or contrastive instance discrimination. In object detection, self-supervised methods can be categorized as backbone pretraining approaches that focus on learning general-purpose feature extractors, and detection-specific pretraining techniques that directly optimize detection performance using synthetic labels or region localization tasks.

For example, UP-DETR and DETReg are transformer-based object detection models employing unsupervised region proposal strategies and random bounding box regression tasks. These models rely on large-scale synthetic pretraining followed by supervised fine-tuning. However, transformer-based methods are computationally intensive and often underperform in scenarios involving visually ambiguous or irregular objects such as fine road cracks.

In parallel, synthetic image generation has been applied for surface-level crack detection. Non-patent literature, such as the synthetic crack segmentation dataset by Supervisely (2023), outlines a three-stage process involving real texture collection, procedural crack generation, and post-processing with style transfer. While effective in generating high-quality training data, procedural generation alone may not reflect the structural randomness and texture variance observed in real-world cracks.

Despite the ongoing research in SSL and YOLO-based road crack detection, the challenge of crack localization in UAV imagery remains. UAV images introduce additional complexities such as varying altitudes, lighting conditions, road texture inconsistencies, and object scale variations. Moreover, classes of damage such as oblique cracks and alligator cracks exhibit high inter-class similarity and low intra-class variation, making classification particularly difficult in the absence of abundant labeled data.

Conventional supervised YOLO models, as detailed in WO2024054815A1 and CN117437201A, primarily utilize static datasets and loss functions focused on regression accuracy. They lack mechanisms to explicitly cluster semantically similar features or to separate visually similar but semantically different classes in the feature space. Furthermore, the pretraining strategies outlined in the prior art do not fully address the imbalance in class distribution often present in crack datasets, nor do they incorporate contrastive loss functions for representation separation.

Accordingly, there exists an ongoing need for systems and methods that can leverage unlabeled aerial image data, automatically generate balanced and diverse training samples, and improve intra-class compactness and inter-class separability in feature representations for more accurate road crack detection.

### SUMMARY

In an exemplary embodiment, a method for detecting one or more object instances in a plurality of target images is disclosed. The method comprises pre-training an object detection model on a synthetic training image set with a contrastive loss, fine-tuning the object detection model on a real training image set having a plurality of annotated object instances, and applying the object detection model on the plurality of target images to detect the one or more object instances and generate corresponding annotations.

In another exemplary embodiment, a system for detecting one or more object instances in a plurality of target images is disclosed. The system comprises a processor configured to pre-train an object detection model on a synthetic training image set with a contrastive loss, fine-tune the pre-trained object detection model on a real training image set having a plurality of annotated object instances, and apply the object detection model on the plurality of target images to detect the one or more object instances and generate corresponding annotations.

In another exemplary embodiment, a non-transitory computer-readable medium is disclosed. The medium stores program instructions that, when executed by processing circuitry, perform a method comprising pre-training an object detection model on a synthetic training image set with a contrastive loss, fine-tuning the pre-trained object detection model on a real training image set having a plurality of annotated object instances, and applying the fine-tuned object detection model on a plurality of target images to detect the one or more object instances and generate corresponding annotations.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A illustrates a system for detecting one or more object instances in a plurality of target images, according to certain embodiments.

FIG. 1B is a schematic diagram illustrating a self-supervised object detection architecture integrating contrastive loss and conventional detection heads for multi-task loss computation, according to certain embodiments.

FIG. 2 is a block diagram illustrating the computation of contrastive loss using cosine similarity between positive and negative embedding pairs obtained from the YOLOv7 encoder, according to certain embodiments.

FIG. 3 is a diagram showing the integration of multiple loss components for training the self-supervised YOLOv7 model, according to certain embodiments.

FIG. 4 is a block-level representation of the training pipeline incorporating contrastive learning through latent space separation of foreground embeddings for different damage types, according to certain embodiments.

FIG. 5 is a schematic illustration of positive and negative patch generation for the contrastive loss computation, according to certain embodiments.

FIG. 6 is a schematic diagram illustrating the computation of contrastive loss (LNCE) for road damage embedding vectors, according to certain embodiments.

FIG. 7 is a diagram depicting the synthetic image generation process, according to certain embodiments.

FIG. 8A is a confusion matrix representing the classification performance of the standard YOLOv7 model across six damage categories on the UADP dataset, according to certain embodiments.

FIG. 8B is a confusion matrix representing the classification performance of the self-supervised YOLOv7 model incorporating LNCE contrastive loss and synthetic pre-training, according to certain embodiments.

FIG. 9 is a comparative bar graph illustrating the average precision of YOLOv7, YOLOv7-E6E, and YOLOv8 models across six damage classes and mean Average Precision at 0.5 IoU, according to certain embodiments.

FIG. 10 is a series of image samples showing detection results by the self-supervised YOLOv7 model alongside ground truth annotations, highlighting instances of successful detection, duplicate predictions, and boundary completeness, according to certain embodiments.

FIG. 11 is an illustration of a non-limiting example of details of computing hardware used in the computing system, according to certain embodiments.

FIG. 12 is an exemplary schematic diagram of a data processing system used within the computing system, according to certain embodiments.

FIG. 13 is an exemplary schematic diagram of a processor used with the computing system, according to certain embodiments.

FIG. 14 is an illustration of a non-limiting example of distributed components which may share processing with the controller, according to certain embodiments.

### DETAILED DESCRIPTION

In the drawings, like reference numerals designate identical or corresponding parts throughout several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Conventional object detection models, including recent variants of YOLO-based architectures, exhibit performance limitations when applied to aerial imagery, particularly in detecting road surface anomalies such as cracks and potholes. These limitations arise due to the lack of distinct object centers, low contrast in visual features, and inadequate training data diversity. Moreover, existing supervised learning methods depend heavily on large-scale annotated datasets, the creation of which is labor-intensive, time-consuming, and subject to annotation inaccuracies. Table 1 illustrates a comparative analysis of various road damage detection technologies.

TABLE 1
Road damage detection technologies

| Technology | Advantages | Disadvantages |
|---|---|---|
| Manual | 1. Low technical cost | 1. Time consuming |
| inspection | | 2. Labor-intensive |
| Inspection | 1. High accuracy | 1. Expensive |
| vehicles | 2. Detection of multiple | equipment |
| | type of road crack | |
| Computer vision | 1. Less expensive | 1. Lower precision |
| | 2. Cutting edge detection | |
| | algorithms could | |
| | be used. | |

The present disclosure addresses the foregoing limitations by introducing a self-supervised contrastive learning framework for object detection, employing a synthetic pre-training stage followed by fine-tuning on real annotated data. A contrastive loss function is utilized during pre-training to enhance representation learning by aligning feature embeddings of similar instances and separating those of dissimilar classes. The object detection model, preferably a self-supervised YOLOv7-based deep learning model, is trained using synthetic images generated by augmenting and compositing foreground instances onto varied background scenes. The present embodiment further supports deployment on unmanned aerial vehicles (UAVs) for real-time road damage detection, delivering substantial improvements in detection accuracy and generalization capability across heterogeneous imaging conditions.

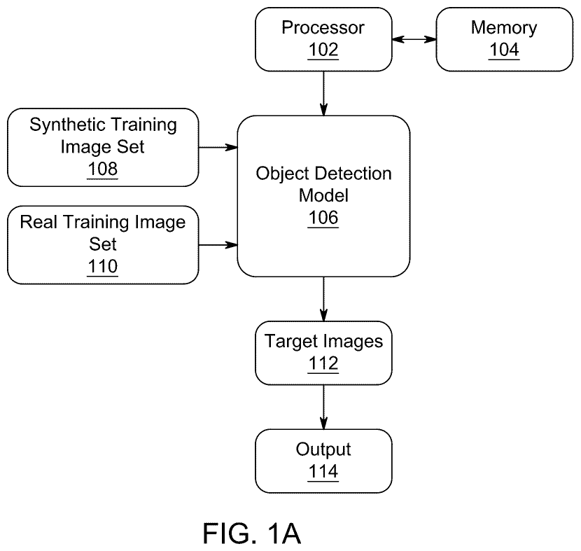

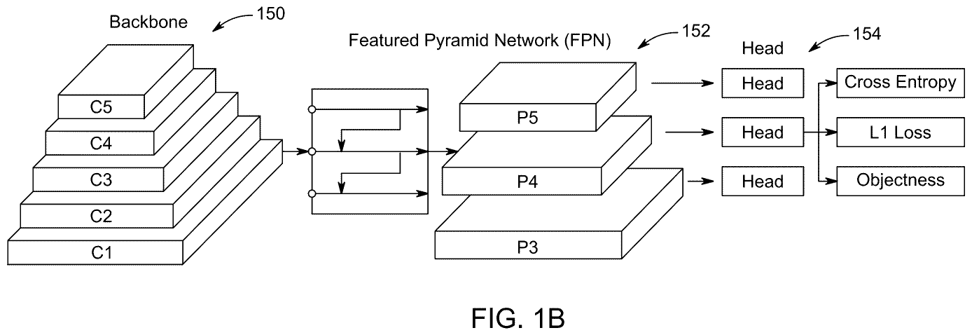

FIG. 1A illustrates a system 100 for detecting one or more object instances in a plurality of target images 112. The system 100 comprises a processor 102, a memory 104, and an object detection model 106. The system 100 is configured to pre-train the object detection model 106 on a synthetic training image set 108 with a contrastive loss, fine-tune the pre-trained object detection model 106 on a real training image set 110 having a plurality of annotated object instances, and apply the object detection model 106 on the plurality of target images 112 to detect the one or more object instances and generate corresponding annotations as output 114.

The processor 102 is implemented as one or more computing units configured to control and coordinate the training, fine-tuning, and inference operations of the object detection model 106. In exemplary embodiments, the processor 102 may include one or more central processing units (CPUs), graphics processing units (GPUs), tensor processing units (TPUs), digital signal processors (DSPs), or combinations thereof. The processor 102 may further include specialized machine learning accelerators such as application-specific integrated circuits (ASICs), field-programmable gate arrays (FPGAs), or system-on-chip (SoC) architectures optimized for parallelized matrix operations. The processor 102 may be integrated within a server-grade data center computing cluster or deployed on edge devices such as mobile platforms, drones, or embedded vision systems.

The memory 104 comprises one or more computer-readable storage mediums configured to store program instructions, model parameters, and training data used by the processor 102. The memory 104 may be implemented using a combination of volatile and non-volatile memory technologies including dynamic random-access memory (DRAM), static RAM (SRAM), NAND flash, hard disk drives (HDDs), solid-state drives (SSDs), read-only memory (ROM), and phase-change memory. In certain embodiments, the memory 104 supports high-throughput access for large-scale model training operations and may be distributed across multiple compute nodes in a cloud infrastructure to facilitate parallel model training.

The object detection model 106 is a machine learning-based detection engine configured to identify and localize one or more object instances within the target images 112. The object detection model 106 is implemented using a deep neural network architecture, such as You Only Look Once version 7 (YOLOv7), Faster R-CNN, or Single Shot Detector (SSD). In one embodiment, the object detection model 106 comprises a backbone network for hierarchical feature extraction, a neck module for multi-scale feature aggregation, and a head module for bounding box regression and class label prediction. The object detection model 106 may incorporate additional modules for attention mechanisms, spatial context integration, or anchor-free detection.

The contrastive images of the synthetic training image set 108 refer to a curated subset of composite image samples generated during the pre-training phase, wherein object instances corresponding to a same class are subject to controlled augmentations and superimposed upon a plurality of background images to create multiple visually distinct representations of similar semantic content. Such contrastive image generation facilitates instance discrimination and embedding separation across class boundaries during self-supervised representation learning.

The synthetic training image set 108 comprises a plurality of synthetically generated images that include artificial object instances created through computer graphics, procedural rendering, or advanced data augmentation techniques. Each image in the synthetic training image set 108 is associated with object annotations, such as bounding boxes and class labels. The synthetic training image set 108 may be generated using three-dimensional rendering engines (e.g., Unity, Unreal Engine), photorealistic texture mapping, and domain randomization techniques to simulate diverse environmental factors such as lighting conditions, occlusions, perspectives, and background textures. In one exemplary embodiment, the synthetic training image set 108 includes aerial images depicting road damages, such as cracks and potholes, rendered under variable weather conditions and geographic scenes to reflect real-world diversity. The aerial images are aerial images of a road surface in one implementation.

In certain embodiments, pre-training the object detection model 106 comprises generating the synthetic training image set 108 by extracting a plurality of object instances from a training image set to form a plurality of foreground images. The term foreground images refer to isolated image patches or regions that contain semantically meaningful object instances (e.g., cracks, potholes, surface depressions), which are manually or algorithmically segmented from original training images. Each foreground image retains the spatial characteristics and contour details of the object instance it represents. These extracted foreground images serve as reusable visual elements for data synthesis and augmentation and act as the core semantic content to be transplanted onto various synthetic backgrounds.

The processor 102 is further configured to augment the foreground images by performing at least one of a resizing action, a cropping action, a reorienting action, and a blurring action, to generate a plurality of augmented foreground images. The resizing action includes altering the spatial dimensions of the foreground images by scaling the image to a target width and height, either uniformly or non-uniformly, such that the aspect ratio may be preserved or modified, while ensuring that the object features remain semantically identifiable. The cropping action includes extracting a sub-region from the original foreground image, which may be performed in a centered, random, or context-aware manner, thereby allowing the object detection model 106 to learn discriminative features from partial or occluded views. The reorienting action includes spatially modifying the orientation of the foreground images by applying operations such as flipping (horizontal or vertical) or rotation (clockwise or counterclockwise by predetermined angles), thereby enabling the pre-trained object detection model 106 to learn invariant features with respect to pose and orientation changes. The blurring action includes applying a blur filter, such as a Gaussian blur, median blur, or motion blur, to reduce high-frequency noise or fine details in the foreground images, thereby enforcing robustness in the object detection model 106 under suboptimal imaging conditions. The augmentation actions are configured to increase the visual variability of the training data while preserving the semantic label consistency of the objects present in the foreground images, thereby enhancing the generalizability and detection performance of the object detection model 106.

The plurality of augmented foreground images is then superimposed onto a plurality of background images to obtain a superimposed image set. Background images may include texture-rich yet semantically neutral road scenes captured from aerial views, devoid of object instances of interest. By embedding the foreground images into such backgrounds, the model learns to identify foreground anomalies against varying spatial and contextual environments.

Subsequently, the processor 102 processes the superimposed image set to obtain the synthetic training image set 108 having one or more annotations for the object instances. In one embodiment, this processing step includes smoothing the edges of the foreground-background boundary and reducing contrast discontinuities using a Contrast Limited Adaptive Histogram Equalization (CLAHE) technique. The CLAHE technique enhances local contrast while preserving overall brightness uniformity and suppressing amplification of noise, thereby producing visually consistent and realistic synthetic images.

During the pre-training phase, the processor 102 executes contrastive learning operations using the synthetic training image set 108. A contrastive loss function is computed to bring closer the learned embeddings of object instances from the same class and to push apart the embeddings of object instances from different classes. This loss formulation enables the object detection model 106 to learn fine-grained intra-class similarity and inter-class dissimilarity in an unsupervised manner. The processor 102 further updates the object detection model 106 by adjusting a plurality of model parameters based on an aggregate loss comprising the contrastive loss and a standard detection loss. The standard detection loss may include a combined classification loss, a regression loss, and an objectness loss, each of which contributes to the supervised fine-tuning of the model on annotated real-world image data.

This multi-stage pre-training and fine-tuning pipeline results in enhanced detection accuracy, especially in low-data regimes, and facilitates effective deployment of the object detection model 106 in aerial image-based damage detection tasks.

The real training image set 110 comprises a plurality of real-world images annotated with ground-truth labels, representing object instances captured under natural conditions. The real training image set 110 may be collected using RGB cameras, UAV-mounted imaging systems, surveillance footage, or crowd-sourced image datasets. In certain embodiments, the real training image set 110 includes high-resolution aerial photographs of roadways with manually annotated damage regions. The annotated instances include bounding boxes, segmentation masks, and confidence labels for objects of interest such as cracks, potholes, debris, and surface irregularities.

During fine-tuning, the processor 102 updates the pre-trained object detection model 106 using the real training image set 110, refining its weights and detection capabilities to better suit real-world conditions. Fine-tuning may be conducted using stochastic gradient descent, adaptive learning rate scheduling, early stopping criteria, and regularization methods such as dropout and weight decay.

The target images 112 represent a new set of unlabeled images on which the pre-trained object detection model 106 is deployed to detect object instances. The target images 112 may originate from real-time data streams or batch uploads from UAV systems, mobile phones, vehicle-mounted cameras, or fixed infrastructure sensors. Each target image may contain one or more object instances of interest, such as road surface damages, vehicle components, industrial defects, agricultural anomalies, or construction site features, depending on the deployment context.

Upon receiving the target images 112, the processor 102 applies the object detection model 106 to detect each image and identify object bounding boxes, class labels, and associated confidence scores. The resulting annotations are compiled as output 114, which may be presented in the form of structured metadata, overlay visualizations, or spatially indexed geographic coordinates.

The output 114 comprises a set of detections including object locations, classes, and detection confidences. In certain embodiments, the output 114 may be integrated with mapping systems, geographic information systems (GIS), asset management dashboards, or inspection planning tools to facilitate actionable insights.

In certain embodiments, the system 100 is configured to perform additional post-processing operations on the output 114, including non-maximum suppression (NMS), instance tracking, image segmentation, or domain-specific filtering (e.g., filtering detections by severity level or proximity to road intersections). In some embodiments, the system 100 is deployed as part of an autonomous UAV inspection pipeline, where the target images 112 are captured in-flight and analyzed in real time to generate the output 114 onboard or via a cloud processing backend.

The system 100 may be implemented across various hardware and software configurations, including embedded GPU platforms (e.g., NVIDIA Jetson), mobile AI accelerators, edge computing gateways, or containerized cloud microservices using orchestration tools such as Kubernetes. The processor 102 may be coupled with network interfaces supporting Wi-Fi, 5G, Ethernet, or satellite communication for secure data exchange between edge and cloud components.

FIG. 1B illustrates an exemplary object detection architecture 150, which may be implemented in various configurations including, but not limited to, a self-supervised YOLOv7-based deep learning model. The architecture 150 is configured to process one or more input images to detect object instances and generate corresponding annotations. The architecture 150 comprises three principal components: a backbone network, a Feature Pyramid Network (FPN) 152, and a detection head 154.

The backbone network includes a hierarchical stack of convolutional layers labeled C1 through C5. The backbone is configured to receive input images and generate multiscale feature maps through successive convolutional operations. The layers C1 and C2 capture low-level spatial features such as edges and textures, while higher-level layers C3 through C5 encode more abstract and semantically rich features such as shapes and object boundaries. The backbone network may be implemented using a wide range of convolutional neural network (CNN) architectures including, but not limited to, ResNet, DenseNet, EfficientNet, CSPDarknet53, or MobileNet, depending on the computational and accuracy requirements of the deployment environment. In certain configurations, the backbone may incorporate self-supervised pre-training using synthetic training image sets with contrastive loss to enhance feature robustness.

The Feature Pyramid Network (FPN) 152 is operably coupled to the backbone and is configured to aggregate and refine the multiscale feature maps generated by the backbone layers. The FPN 152 generates a set of output feature maps P3, P4, and P5, each corresponding to a different spatial resolution. The multiscale feature representation enables robust detection of object instances of varying sizes. The FPN may implement a top-down pathway with lateral connections, upsampling modules, and spatial attention mechanisms. In certain embodiments, the FPN may also incorporate dense connections or recursive feature fusion to improve gradient propagation and cross-scale feature interaction.

The detection head 154 is operably coupled to each of the output feature maps P3, P4, and P5, and is configured to perform final object detection tasks including object classification, bounding box regression, and objectness scoring. Each detection head includes a series of convolutional or fully connected layers that process the input feature map to generate detection outputs. Specifically, each head is configured to compute a combined classification loss using a cross-entropy loss, a regression loss using an L1 loss for bounding box coordinate predictions, and an objectness loss indicating the likelihood of an object instance being present in the region of interest. These loss components collectively constitute a standard detection loss.

The object detection model is configured to be pre-trained using the synthetic training image set by computing the contrastive loss over the synthetic training image set to bring a plurality of embeddings of the object instances of a same class closer together and to push apart embeddings of the object instances of different classes. The contrastive loss encourages the model to learn class-discriminative and instance-invariant representations. The object detection model is further configured to be updated by adjusting a plurality of model parameters based on an aggregate loss comprising the contrastive loss and the standard detection loss.

The architecture 150 may be further configured to evaluate a detection performance of the object detection model on a validation image set using precision, recall, and mean average precision metrics. These performance metrics are used to quantitatively assess the effectiveness of the model in terms of detection accuracy and robustness.

In certain deployments, the object detection model is further configured to be deployed on an unmanned aerial vehicle (UAV) to perform road crack detection. In such configurations, the UAV may capture aerial imagery of road surfaces and transmit the images to the onboard or remote object detection architecture for processing. In one implementation, the object detection model is a self-supervised YOLOv7-based deep learning model that achieves at least an 8% increase in mean average precision relative to a baseline YOLOv7-based deep learning model trained without the contrastive loss pre-training. This performance improvement highlights the efficacy of the contrastive learning-based pre-training strategy.

Additionally, the object detection model is configured such that pre-training and fine-tuning of the object detection model are performed based on an instance localization self-supervised learning (InsLoc) technique. The InsLoc technique enables the model to learn object localization patterns without requiring extensive manual annotations, thereby improving scalability and adaptability to diverse datasets. The modular nature of the architecture 150 allows for dynamic reconfiguration of its components and supports deployment across various platforms including edge devices, mobile systems, and cloud infrastructures.

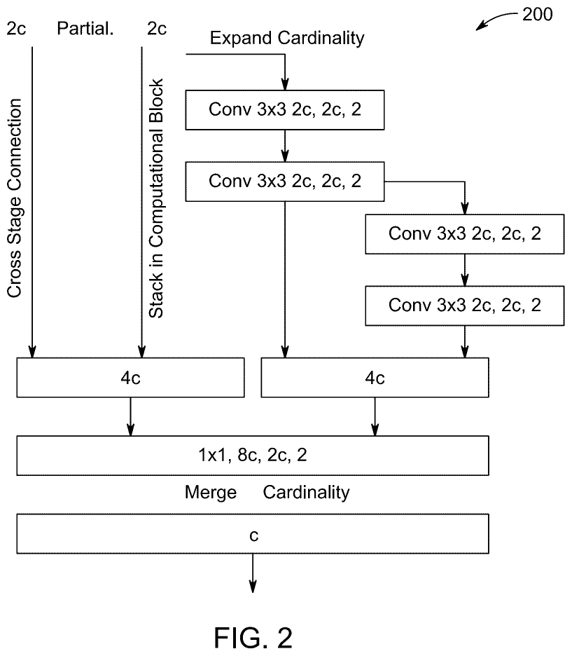

FIG. 2 illustrates an extended efficient layer aggregation network 200 implemented within the backbone of an object detection model, according to certain embodiments. The extended efficient layer aggregation network 200, also referred to as E-ELAN, is configured to extract deep hierarchical features from an input image by leveraging a sequence of internal operations that include expand, shuffle, and consolidate operations. These operations are integrated to enhance the learning capacity of the model while preserving gradient flow continuity during training.

The expand operation within the E-ELAN architecture is configured to increase the representational capacity of the network by widening the feature space. In certain embodiments, the expand operation comprises increasing the number of convolutional branches or channels in a given layer to capture diverse spatial and semantic patterns. For instance, in one implementation, the input feature map is expanded to multiple parallel paths using grouped convolutional layers, each operating with distinct kernel sizes.

The shuffle operation within the E-ELAN architecture is configured to improve cross-channel feature interaction by reorganizing the expanded feature maps. In one exemplary configuration, the shuffle operation applies channel shuffling across the output feature maps of grouped convolutions to facilitate inter-group information exchange, thereby mitigating channel-wise redundancy and enhancing representational richness.

The consolidate operation is configured to aggregate the processed feature maps from the expanded and shuffled branches. In certain embodiments, the consolidate operation comprises a concatenation or addition operation, followed by a normalization and activation function, to fuse the features into a unified representation. The consolidate operation enables efficient information integration across multiple convolutional paths, thereby preserving relevant spatial and semantic information.

The E-ELAN network 200 is integrated within the backbone of the object detection system to facilitate multi-level feature extraction from both synthetic training images and real training images. In certain configurations, the backbone includes additional normalization layers, skip connections, and activation functions such as ReLU or SiLU to improve training stability and convergence. The E-ELAN network 200 is scalable and may be configured with different depths, widths, and layer arrangements depending on the computational resources and object detection objectives.

The E-ELAN network 200 may be executed by a processor that includes hardware configurations such as a central processing unit (CPU), graphics processing unit (GPU), tensor processing unit (TPU), or field-programmable gate array (FPGA). The processor is operably coupled to memory storing program instructions configured to control feature extraction for target images. Target images include real training images captured from camera feeds and synthetic training images generated via data augmentation or simulation-based rendering.

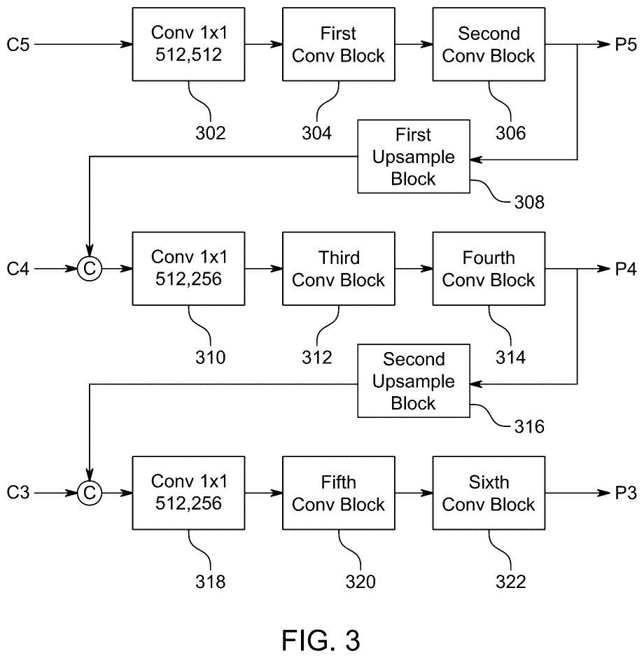

FIG. 3 illustrates a featured pyramid network (FPN) architecture configured for multi-scale feature generation in an object detection system, according to certain embodiments. The FPN architecture is denoted generally by a sequence of convolutional and upsampling operations that refine feature representations derived from different levels of a backbone network. The architecture accepts hierarchical input features C5, C4, and C3, and produces refined feature maps P5, P4, and P3 through sequential processing.

The feature map C5 is initially processed by a first convolutional block 302, which comprises a 1×1 convolution configured to map a 512-channel input to a 512-channel output, preserving the spatial dimensions while reducing computational complexity. The output of block 302 is passed to a second convolutional block 304, which performs a sequence of 3×3 convolutional operations for spatial feature refinement. The resulting output is processed by a third convolutional block 306, which further extracts semantic features and generates a feature map P5, serving as the top-level output of the pyramid.

A first upsample block 308 receives the output of the third convolutional block 306 and performs spatial upsampling to match the resolution of the mid-level feature map C4. The first upsample block 308 may be implemented using bilinear interpolation, nearest-neighbor upsampling, or transposed convolution depending on system design. The upsampled feature is concatenated with the feature map C4 to facilitate feature fusion across scales.

The concatenated feature map is processed by a fourth convolutional block 310, which includes a 1×1 convolution mapping a 512-channel input to a 256-channel output. This enables channel reduction and efficient combination of semantic and mid-level features. The output of the fourth convolutional block 310 is passed sequentially through a fifth convolutional block 312 and a sixth convolutional block 314, each comprising 3×3 convolutions with activation and normalization layers to generate a refined output feature map P4.

The second upsample block 316 receives the output of the sixth convolutional block 314 and upsamples the feature map to align with the spatial resolution of the low-level feature map C3. The upsampling is followed by a concatenation with the feature map C3, forming a composite input for the next stage.

The concatenated output is processed by a seventh convolutional block 318, which includes a 1×1 convolution mapping 512 channels to 256 channels. The reduced representation is further refined using an eighth convolutional block 320 and a ninth convolutional block 322, each configured with 3×3 convolution kernels. The final output of the ninth convolutional block 322 corresponds to the feature map P3, containing fine-grained spatial details suitable for small object detection.

Each of the convolutional blocks (302, 304, 306, 310, 312, 314, 318, 320, and 322) may be implemented using hardware-accelerated units, including but not limited to graphics processing units (GPUs), tensor processing units (TPUs), application-specific integrated circuits (ASICs), or field-programmable gate arrays (FPGAs). Activation functions such as Leaky ReLU, SiLU, or GELU may be incorporated within each block for non-linearity. Normalization techniques such as batch normalization or group normalization may be used to stabilize the training process.

The upsample blocks (308 and 316) are configured to preserve feature semantics during resolution enlargement and may support different modes such as fixed-ratio upsampling or learnable deconvolution-based operations.

The hierarchical output feature maps P5, P4, and P3 represent high-level, mid-level, and low-level features respectively. These are used for detecting large, medium, and small objects in the downstream object detection head. The FPN architecture shown in FIG. 3 is applicable to multiple configurations of object detection systems, including but not limited to those using YOLO-based detectors, RetinaNet, or transformer-based detection frameworks. The system supports training using synthetic and real training images and is configured for inference on target images during deployment.

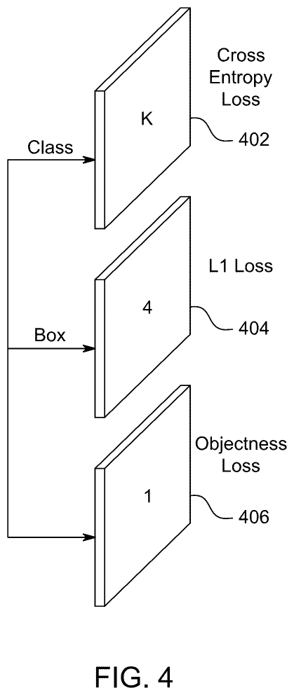

FIG. 4 illustrates a head architecture 400 for an object detection system, wherein the architecture 400 is configured to perform multi-task prediction and loss computation. The head architecture 400 processes feature map outputs from preceding stages and computes distinct loss values to guide the training of the object detection model. The head architecture 400 comprises a first loss computation unit 402, a second loss computation unit 404, and a third loss computation unit 406.

The first loss computation unit 402 is configured to determine a classification loss based on cross-entropy. The classification head receives class-related features and produces a class probability map of dimension K, corresponding to the number of target classes. The cross-entropy loss function measures the divergence between the predicted class probabilities and the ground truth labels. The classification loss is computed using the following equation:

$${loss}_{cross - entropy} = - {\sum }_{i = 1}^{x} p ( x ) \cdot log ( q ( x ) ) \qquad ( 1 )$$

where p(x) represents the true class distribution, and q(x) denotes the predicted probability distribution over the classes. The computed cross-entropy loss guides the optimization of class prediction performance by penalizing deviations from the ground truth distribution.

The second loss computation unit 404 is configured to compute a bounding box regression loss using the L1 loss function. The bounding box head receives input features related to box localization and produces a four-dimensional vector representing the predicted coordinates of the bounding box. The L1 loss function calculates the absolute error between the predicted and true bounding box coordinates. The L1 loss is computed using the following equation:

$${L}_{1} = - {\sum }_{i = 1}^{x} \vert {y}_{true} - {y}_{predicted} \vert \qquad ( 2 )$$

where yₜᵣᵤₑ and y_{predicted} correspond to the true and predicted bounding box values, respectively. The L1 loss encourages the learning of precise object localization during training.

The third loss computation unit 406 is configured to calculate an objectness loss value based on binary classification. The objectness head receives confidence features and predicts the presence or absence of an object within a particular grid cell. The objectness loss output assumes a value of 1 if an object is present and its predicted bounding box exhibits an intersection over union (IoU) greater than 0.5 with the ground truth, and a value of 0 otherwise. This loss encourages the model to distinguish between object-containing and background regions, enhancing detection reliability.

Each of the three heads, the classification head, the bounding box head, and the objectness head, are jointly optimized during training. The outputs of the head architecture 400 feed into a unified loss function that aggregates all three loss components to iteratively update the model weights through backpropagation. The described architecture enables accurate classification, localization, and confidence scoring, and may be configured using alternate loss formulations such as GIoU, focal loss, or smooth L1, depending on deployment requirements.

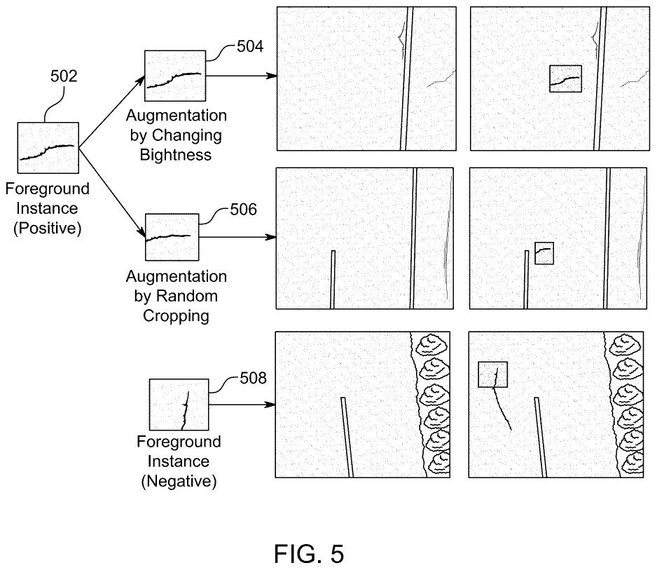

FIG. 5 illustrates the pre-training stage of the YOLOv7-based object detection system, wherein synthetic foreground instances are utilized to augment the training dataset using self-supervised techniques, according to certain embodiments. A positive foreground instance 502, representing an image patch containing a road damage feature, is subjected to augmentation operations to generate synthetic variations. A brightness augmentation module 504 modifies the luminance characteristics of the foreground instance 502 to create an augmented patch for robust training under illumination variance. A cropping augmentation module 506 performs random cropping of the foreground instance 502 to simulate spatial variability in damage localization. These augmented foreground patches are then superimposed on background pavement regions to generate composite training images for contrastive learning. A negative foreground instance 508, which contains no damage or irrelevant background texture, is also overlaid onto pavement backgrounds to generate visually similar but semantically different negative examples. Bounding box annotations are preserved during this augmentation to facilitate region-based encoding in subsequent stages. The objective of this augmentation pipeline is to enable the system to distinguish between road damages and non-damages, thereby reinforcing feature learning in the encoder architecture.

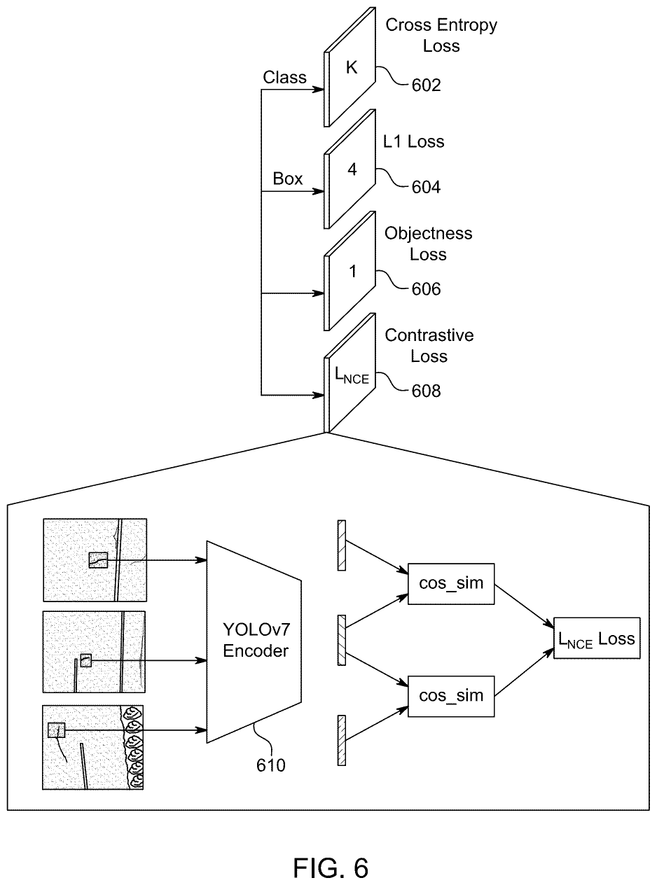

FIG. 6 illustrates the computation of a contrastive loss function LNCE, integrated within the head of the YOLOv7-based object detection system, according to certain embodiments. A classification head outputs a classification tensor 602 comprising K channels, each representing a different object category, and the associated loss is computed using a cross-entropy loss function. A regression head outputs a bounding box tensor 604 with four channels for box coordinates, where the loss is computed using an L1 loss function. An objectness head outputs a scalar tensor 606 indicating object presence, trained using an objectness loss function. Additionally, a contrastive loss module 608 is incorporated to enhance representation learning by minimizing the distance between latent embeddings of semantically similar instances while maximizing the distance between dissimilar ones. The contrastive loss is computed based on a similarity metric cosₛᵢₘ and is integrated as a fourth output loss channel in the head of the architecture.

The contrastive loss computation is further detailed in the lower half of FIG. 6. The YOLOv7 encoder 610 receives as input a set of positive foreground patches and a negative foreground patch, such as those illustrated in FIG. 5. The encoder 610 processes each input to obtain a corresponding latent embedding. A cosine similarity operation is applied between pairs of embeddings representing anchor-positive (similar) and anchor-negative (dissimilar) relationships. The cosine similarity is computed by:

$${cos}_{sim ( u , v )} = \frac{{u}^{T} v}{‖ u ‖ . \vert \cdot \vert v \vert \vert} \qquad ( 3 )$$

where, cos is the cosine function that computes the similarity of two vectors u and v in the embedding space.

$${L}_{NCE} = - log \frac{exp ( \frac{sim ( q , k + )}{τ} )}{exp ( \frac{sim ( q , k + )}{τ} ) + exp ( \frac{sim ( q , k - )}{τ} )} \qquad ( 4 )$$

where q denotes the anchor instance, k+ represents a positive instance derived from another augmentation of the same source, k− is a semantically dissimilar negative instance, and τ is a temperature coefficient. The contribution of the computed similarity measure lies in the range of 0.1 to 0.5. In one aspect, τ was set to 0.1. The L_{NCE} term is scaled by a small coefficient to ensure it complements rather than dominates the YOLO-specific losses. This hybrid loss configuration enables the network to learn highly discriminative features suitable for detecting visually similar yet semantically distinct road surface anomalies.

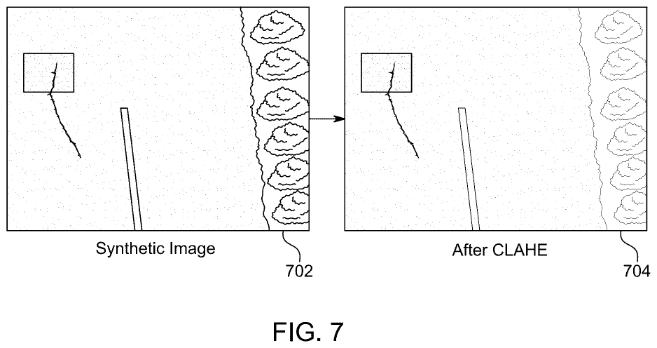

FIG. 7 illustrates a synthetic image generation pipeline for pre-training the YOLOv7 model, in accordance with certain embodiments. A synthetic image 702 is generated by superimposing cropped foreground instances of road damage onto a background image. The synthetic image 702 is subjected to a Contrast Limited Adaptive Histogram Equalization (CLAHE) operation with a clip limit of 2 to produce a CLAHE-enhanced image 704. The CLAHE operation enhances contrast within local regions, thereby reducing the visual discrepancy between the synthetic foreground and the natural background. The enhanced image 704 simulates a more realistic road condition with subtle crack patterns to improve the robustness of YOLOv7 pre-training against real-world data variations. In one embodiment, the synthetic image generation is performed using 10 background images cropped from the training set and resized to a resolution of 500×500 pixels. A total of 30 road damage foreground instances, selected from various damage types including transverse, longitudinal, oblique, pothole, alligator, and repair, are extracted and subjected to Gaussian blurring filters using a 5×5 square kernel with standard deviation values randomly sampled from the interval [0.1, 2.0]. The blurred instances are then randomly positioned within the background image to form a composite. The complete pre-training dataset comprises 1800 such synthetic images.

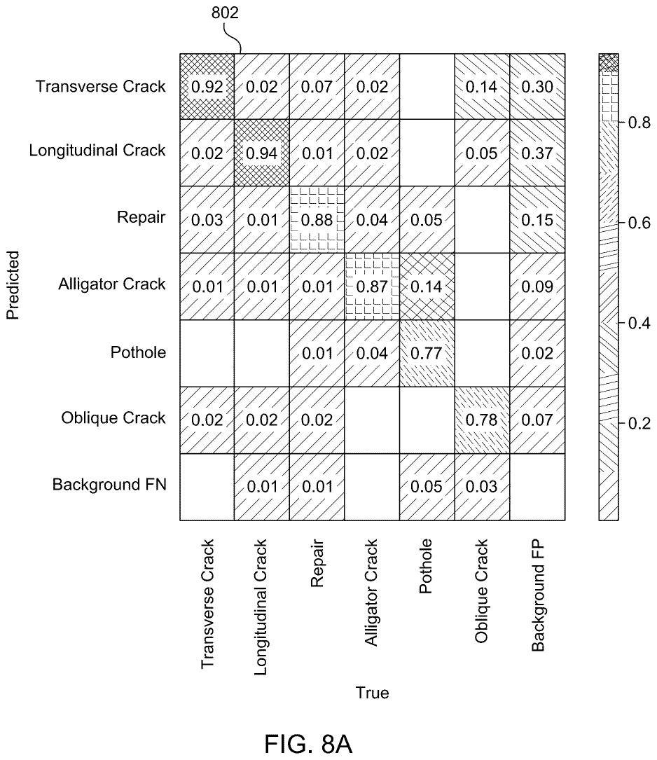

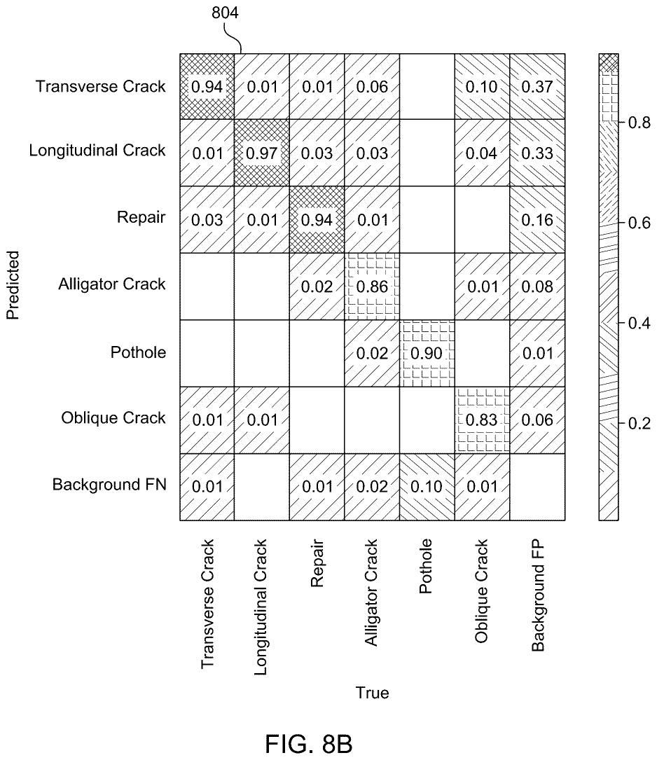

FIG. 8A illustrates a confusion matrix 802 for the standard YOLOv7 model evaluated on the UADP dataset, according to certain embodiments. The UADP dataset includes 2401 images, each having a resolution of 500×500 pixels, representing six road damage classes: transverse cracks, longitudinal cracks, alligator cracks, oblique cracks, potholes, and repair. The matrix 802 summarizes the prediction performance of the YOLOv7 model across these damage classes. Diagonal entries indicate correct predictions while off-diagonal entries indicate misclassifications. YOLOv7 achieves high accuracy in detecting transverse and longitudinal cracks but underperforms in detecting potholes and oblique cracks. A high false negative rate is observed, especially for oblique cracks and background misclassifications, demonstrating the limitations of the baseline model in detecting low-contrast or irregularly shaped damage features. Specifically, the standard YOLOv7 model records an approximate false negative rate of 0.10. Crack type differentiation is based on orientation with respect to the street direction: longitudinal cracks fall within 0-30 degrees, oblique cracks within 30-60 degrees, and transverse cracks within 60-90 degrees.

Table 2 lists the number of instances for each class. Form Table 2, it is evident that the majority of instances are related to transverse and longitudinal crack types.

TABLE 2
UADP Dataset Description.

| Damage type | Longitudinal | Transverse | Alligator | Oblique | Repair | Pothole |
|---|---|---|---|---|---|---|
| Total instances | 1264 | 1263 | 293 | 162 | 769 | 86 |

The angle with respect to the street direction is used as a standard to differentiate between longitudinal, oblique, and transverse as shown in Table 3.

TABLE 3
The distinction between crack types

| Crack Type | Angle with the street direction |
|---|---|
| Longitudinal | 0-30 |
| Oblique | 30-60 |
| Transverse | 60-90 |

FIG. 8B illustrates a confusion matrix 804 for the self-supervised YOLOv7 model incorporating the LNCE contrastive loss and pre-training on synthetically generated images, according to certain embodiments. The matrix 804 evidences a substantial performance improvement over the baseline model, with increased true positive rates across all classes and notably reduced false negative entries. As compared to FIG. 8A, improvements are particularly prominent in the detection of potholes and oblique cracks, with up to 0.127 improvement in average precision (AP) for potholes and 0.041 for longitudinal cracks. The enhancement is attributed to the pre-training stage and the LNCE contrastive loss, which encourages clustering of same-class instances while dispersing different-class features in the latent space. The confusion matrix 804 demonstrates enhanced discriminability of similar crack patterns such as alligator versus transverse or oblique cracks, reducing their prior misclassification. The overall false negative rate is approximately reduced from 0.10 to 0.06, indicating improved model sensitivity. Both models were evaluated using a training to testing split ratio of 80:20, with 10% of the training set used as a validation set. Table 4 provides the parameter settings utilized in this experiment. In one example, the machine utilized to train and test the implemented models in this study was equipped with eight NVIDIA RTX A6000 GPUs, each with 48 GB of RAM, and ran on the Ubuntu operating system.

TABLE 4
Hyperparameters settings

| Parameters | Value |
|---|---|
| Train:Test | 80:20 |
| Epochs | 300 |
| Momentum | 0.3 |
| Image size | 640 |
| Initial learning rate | 1e−5 |
| Final learning rate | 0.01 |
| Batch size | 32 |
| confidence threshold | 0.001 |
| Non-maximum suppression NMS | 0.65 |
| Gaussian blurring kernel | 5 × 5 |
| τ | 0.1 |

The evaluation metrics include precision, recall, and mean Average Precision (mAP), with an Intersection over Union (IoU) threshold of 0.5 used to determine detection correctness. Formulas for determining the precision, recall, mAP, and IoU functions are:

$$Precision = \frac{TP}{TP + FP} \qquad ( 5 )$$

$$Recall = \frac{TP}{TP + FN} \qquad ( 6 )$$

Where TP is the total of true positives, FP is the total of false positives, and FN is the total of false negatives.

$$mAP = \frac{{\sum }_{i = 0}^{k} Ap ( i )}{k} \qquad ( 7 )$$

$$AP = {\int }_{0}^{1} p ( r ) dr \qquad ( 8 )$$

where AP (average precision) is defined as the integral of each category's recall rate, with upper and lower bounds of 1 and 0 respectively.

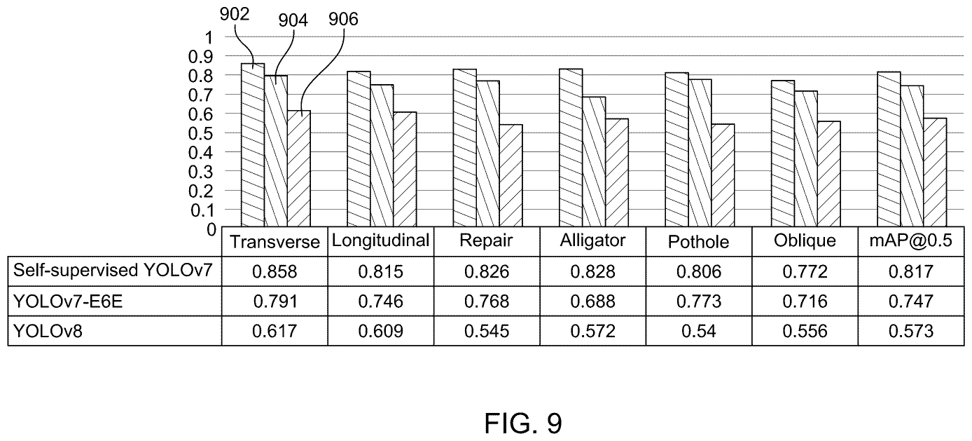

FIG. 9 illustrates a comparative bar graph demonstrating the detection performance of different object detection models for road damage classification, including a self-supervised YOLOv7 model 902, a YOLOv7-E6E model 904, and a YOLOv8 model 906. Each bar represents the average precision (AP) for a respective damage category, including transverse crack, longitudinal crack, repair, alligator crack, pothole, and oblique crack, as well as the overall mean Average Precision (mAP) at an Intersection over Union (IoU) threshold of 0.5. The self-supervised YOLOv7 model 902 demonstrates superior accuracy across all damage types, achieving AP values of 0.858 for transverse cracks, 0.815 for longitudinal cracks, 0.826 for repairs, 0.828 for alligator cracks, 0.806 for potholes, and 0.772 for oblique cracks, resulting in an mAP@0.5 of 0.817. The YOLOv7-E6E model 904 shows lower values, particularly for oblique cracks (0.716), which are known to be visually similar to alligator cracks. YOLOv8 model 906, characterized by its anchor-free detection framework, performs the poorest due to its reliance on object center estimation, an unsuitable strategy for fine-grained crack types with undefined spatial centroids, yielding an mAP@0.5 of 0.573. This result substantiates the effectiveness of the contrastive loss augmentation and synthetic pre-training incorporated in the self-supervised YOLOv7 model 902. The models were trained using 300 epochs with a batch size of 32, confidence threshold set at 0.001, and non-maximum suppression (NMS) threshold set to 0.65.

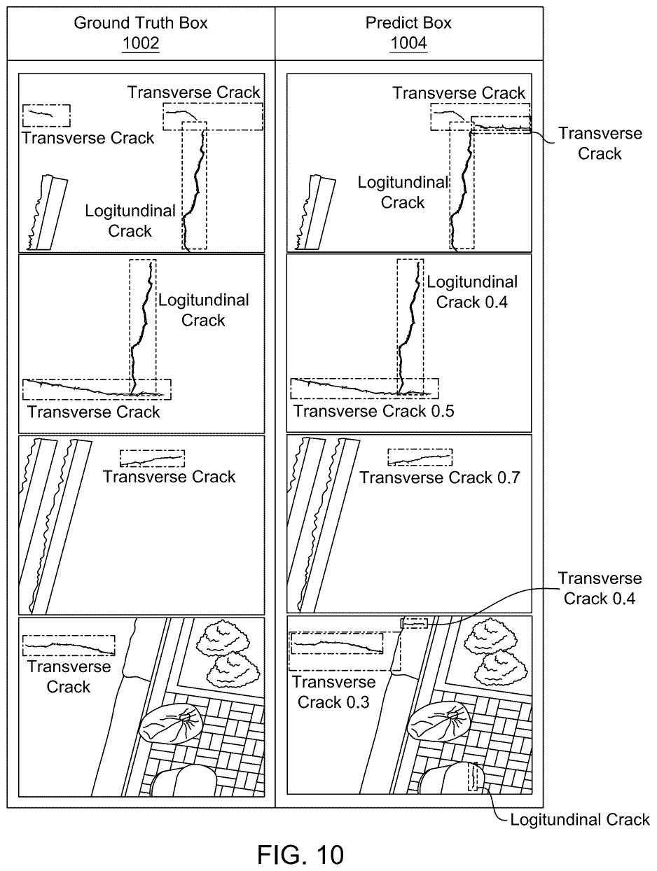

FIG. 10 illustrates a set of comparative image samples showing detection results from the self-supervised YOLOv7 model, depicting both the annotated ground truth bounding boxes 1002 and the predicted bounding boxes 1004. The left column represents the ground truth 1002 for various crack categories, including transverse and longitudinal cracks, while the right column shows the model's predictions 1004 over the same images. The first row demonstrates successful detection of both a transverse and a longitudinal crack, with high spatial alignment between the predicted box 1004 and the ground truth box 1002. The second and third rows further depict accurate single-instance detections of transverse cracks with no false positives or false negatives, indicating strong localization performance and minimal overfitting. In the fourth row, duplicate predictions for a single longitudinal crack are observed, attributed to the non-maximum suppression (NMS) threshold being configured to 0.65. This setting allows multiple bounding boxes to remain if their intersection-over-union (IoU) values do not exceed the NMS threshold, resulting in over-detection. Reducing the NMS threshold could mitigate this issue but may increase the false negative rate. The fifth and sixth rows confirm robust detection performance across diverse surface conditions and orientations. While the fifth row demonstrates consistent detection of a transverse crack in complex background textures, the sixth row shows partial bounding of a longitudinal crack, indicating that finer threshold adjustments may enhance bounding box completeness. Overall, the detection outcomes visualized in FIG. 10 validate the superior generalization, reduced false alarm (FP) rate, and enhanced crack-type discrimination achieved by the self-supervised YOLOv7 model following synthetic data pre-training and incorporation of contrastive loss in the training pipeline. The dataset annotations and visualizations reflect challenging conditions including low contrast, overlapping artifacts, and heterogeneous textures.

The present disclosure introduces a self-supervised YOLOv7 object detection model configured for detecting various types of road damage using the UAPD dataset acquired by an unmanned aerial vehicle (UAV). The results indicate that the self-supervised YOLOv7 model of the present disclosure improves the detection performance of the standard YOLOv7 model by more than 8% in terms of mean Average Precision (mAP). The highest accuracy is obtained in the localization of transverse and longitudinal cracks. However, the detection performance for oblique cracks remains lower due to the limited number of training samples and the visual similarity of oblique cracks to other crack categories.

The results further show that the detection accuracy of the self-supervised YOLOv7 model is enhanced in comparison with the baseline YOLOv7 model and other deep-learning models applied to the same dataset. Visualization analysis supports that the method produces a low false alarm rate, thereby confirming the operational effectiveness of the approach.

The present disclosure extends to the application of self-supervised learning to YOLOv8 and other model variants. The present disclosure may also be applied in additional domains where training data are limited, including industrial inspection and medical diagnostics, such as in defect detection and lesion detection applications.

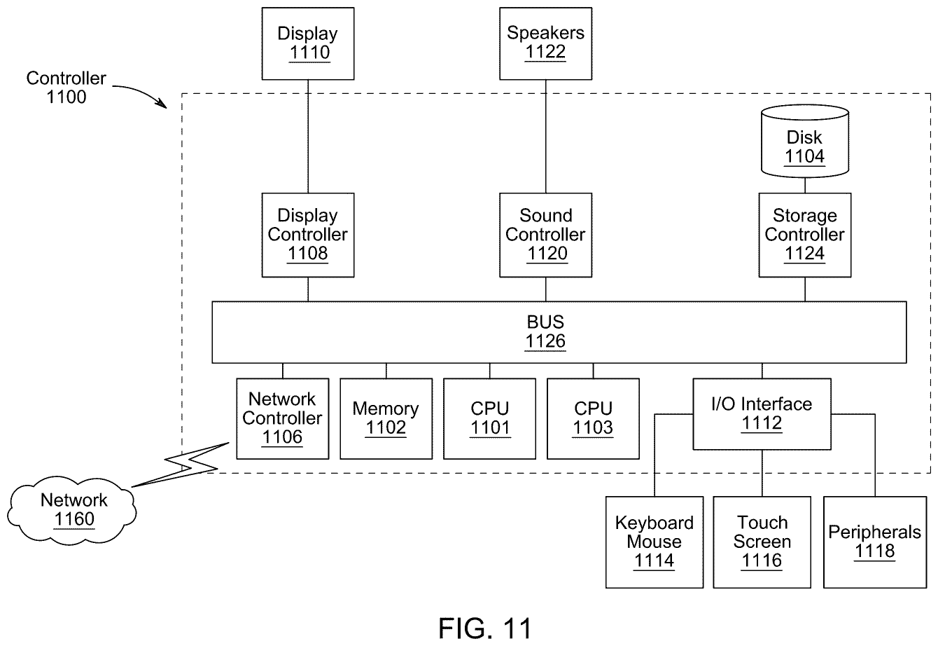

Next, further details of the hardware description of the computing environment according to exemplary embodiments is described with reference to FIG. 11. In FIG. 11, a controller 1100 is described is representative of the system 100 of FIG. 1A in which the controller is a computing device which includes a CPU 1101 which performs the processes described above/below. The process data and instructions may be stored in memory 1102. These processes and instructions may also be stored on a storage medium disk 1104 such as a hard drive (HDD) or portable storage medium or may be stored remotely.

Further, the present disclosure is not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the present disclosure may be provided as a utility application, background daemon, or component of an operating system, or combination thereof, executing in conjunction with CPU 1101, 1103 and an operating system such as Microsoft Windows 7, Microsoft Windows 10, UNIX, LINUX, Apple MAC-OS and other systems known to those skilled in the art.

The hardware elements in order to achieve the computing device may be realized by various circuitry elements, known to those skilled in the art. For example, CPU 1101 or CPU 1103 may be a Xenon or Core processor from Intel of America or an Opteron processor from AMD of America, or may be other processor types that would be recognized by one of the ordinary skill in the art. Alternatively, the CPU 1101, 1103 may be implemented on an FPGA, ASIC, PLD or using discrete logic circuits, as one of ordinary skill in the art would recognize. Further, CPU 1101, 1103 may be implemented as multiple processors cooperatively working in parallel to perform the instructions of the inventive processes described above.

The computing device in FIG. 11 also includes a network controller 1106, such as an Intel Ethernet PRO network interface card from Intel Corporation of America, for interfacing with network 1160. As can be appreciated, the network 1160 can be a public network, such as the Internet, or a private network such as an LAN or WAN network, or any combination thereof and can also include PSTN or ISDN sub-networks. The network 1160 can also be wired, such as an Ethernet network, or can be wireless such as a cellular network including EDGE, 3G, 4G, and 5G wireless cellular systems. The wireless network can also be WiFi, Bluetooth, or any other wireless form of communication that is known.

The computing device further includes a display controller 1108, such as a NVIDIA Geforce GTX or Quadro graphics adaptor from NVIDIA Corporation of America for interfacing with display 1110, such as a Hewlett Packard HPL2445w LCD monitor. A general purpose I/O interface 1112 interfaces with a keyboard and/or mouse 1114 as well as a touch screen panel 1116 on or separate from display 1110. General purpose I/O interface also connects to a variety of peripherals 1118 including printers and scanners, such as an OfficeJet or DeskJet from Hewlett Packard.

A sound controller 1120 is also provided in the computing device such as Sound Blaster X-Fi Titanium from Creative, to interface with speakers/microphone 1122 thereby providing sounds and/or music.

The general purpose storage controller 1124 connects the storage medium disk 1104 with communication bus 1126, which may be an ISA, EISA, VESA, PCI, or similar, for interconnecting all of the components of the computing device. A description of the general features and functionality of the display 1110, keyboard and/or mouse 1114, as well as the display controller 1108, storage controller 1124, network controller 1106, sound controller 1120, and general purpose I/O interface 1112 is omitted herein for brevity as these features are known.

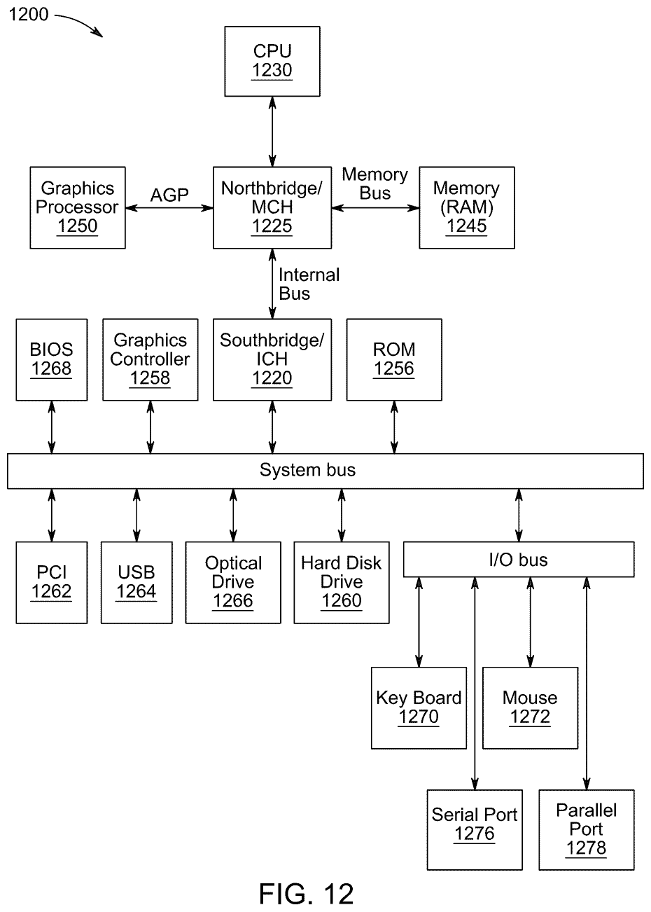

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 12.

FIG. 12 shows a schematic diagram of a data processing system 1200, according to certain embodiments, for performing the functions of the exemplary embodiments. The data processing system 1200 is an example of a computer in which code or instructions implementing the processes of the illustrative embodiments may be located.

In FIG. 12, the data processing system 1200 employs a hub architecture including a north bridge and memory controller hub (NB/MCH) 1225 and a south bridge and input/output (I/O) controller hub (SB/ICH) 1220. The central processing unit (CPU) 1230 is connected to NB/MCH 1225. The NB/MCH 1225 also connects to the memory 1245 via a memory bus, and connects to the graphics processor 1250 via an accelerated graphics port (AGP). The NB/MCH 1225 also connects to the SB/ICH 1220 via an internal bus (e.g., a unified media interface or a direct media interface). The CPU Processing unit 1230 may contain one or more processors and even may be implemented using one or more heterogeneous processor systems.

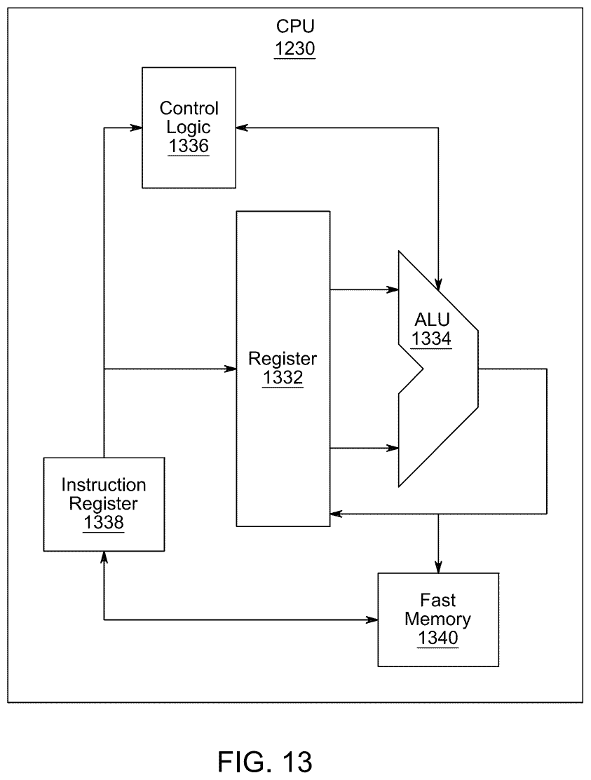

For example, FIG. 13 shows one implementation of CPU 1230. In one implementation, the instruction register 1338 retrieves instructions from the fast memory 1340. At least part of these instructions are fetched from the instruction register 1338 by the control logic 1336 and interpreted according to the instruction set architecture of the CPU 1230. Part of the instructions can also be directed to the register 1332. In one implementation the instructions are decoded according to a hardwired method, and in another implementation the instructions are decoded according to a microprogram that translates instructions into sets of CPU configuration signals that are applied sequentially over multiple clock pulses. After fetching and decoding the instructions, the instructions are executed using the arithmetic logic unit (ALU) 1334 that loads values from the register 1332 and performs logical and mathematical operations on the loaded values according to the instructions. The results from these operations can be feedback into the register and/or stored in the fast memory 1340. According to certain implementations, the instruction set architecture of the CPU 1230 can use a reduced instruction set architecture, a complex instruction set architecture, a vector processor architecture, and a very large instruction word architecture. Furthermore, the CPU 1230 can be based on the Von Neuman model or the Harvard model. The CPU 1230 can be a digital signal processor, an FPGA, an ASIC, a PLA, a PLD, or a CPLD. Further, the CPU 1230 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 12, the data processing system 1200 can include that the SB/ICH 1220 is coupled through a system bus to an I/O Bus, a read only memory (ROM) 1256, universal serial bus (USB) port 1264, a flash binary input/output system (BIOS) 1268, and a graphics controller 1258. PCI/PCIe devices can also be coupled to SB/ICH 1288 through a PCI bus 1262.

The PCI devices may include, for example, Ethernet adapters, add-in cards, and PC cards for notebook computers. The Hard disk drive 1260 and CD-ROM 1266 can use, for example, an integrated drive electronics (IDE) or serial advanced technology attachment (SATA) interface. In one implementation the I/O bus can include a super I/O (SIO) device.

Further, the hard disk drive (HDD) 1260 and optical drive 1266 can also be coupled to the SB/ICH 1220 through a system bus. In one implementation, a keyboard 1270, a mouse 1272, a parallel port 1278, and a serial port 1276 can be connected to the system bus through the I/O bus. Other peripherals and devices that can be connected to the SB/ICH 1220 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry, or based on the requirements of the intended back-up load to be powered.

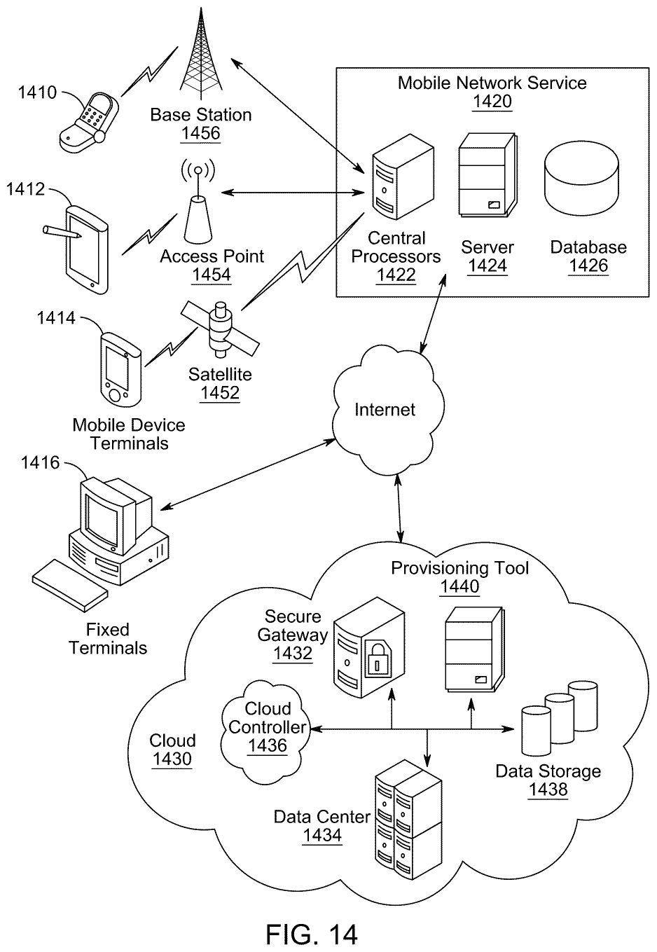

The functions and features described herein may also be executed by various distributed components of a system. For example, one or more processors may execute these system functions, wherein the processors are distributed across multiple components communicating in a network. The distributed components may include one or more client and server machines, which may share processing, as shown by FIG. 14, in addition to various human interface and communication devices (e.g., display monitors, smart phones, tablets, personal digital assistants (PDAs)). More specifically, FIG. 14 illustrates client devices including a smart phone 1431, a tablet 1432, a mobile device terminal 1434 and fixed terminals 1436. These client devices may be commutatively coupled with a mobile network service 1440 via a base station 1456, an access point 1454, a satellite 1452 or via an internet connection. The mobile network service 1440 may comprise central processors 1442, a server 1444 and a database 1446. The fixed terminals 1436 and the mobile network service 1440 may be commutatively coupled via an internet connection to functions in cloud 1450 that may comprise a security gateway 1452, a data center 1454, a cloud controller 1456, a data storage 1458 and a provisioning tool 1460. The network may be a private network, such as the LAN or the WAN, or may be the public network, such as the Internet. Input to the system may be received via direct user input and received remotely either in real-time or as a batch process. Additionally, some implementations may be performed on modules or hardware not identical to those described. Accordingly, other implementations are within the scope that may be disclosed.

The above-described hardware description is a non-limiting example of corresponding structure for performing the functionality described herein.

Numerous modifications and variations of the present disclosure are possible in light of the above teachings. It is therefore to be understood that aspects of the present disclosure may be practiced otherwise than as specifically described herein.

1. A method for detecting one or more object instances in a plurality of target images, comprising:
pre-training an object detection model on a synthetic training image set with a contrastive loss;
fine-tuning the object detection model on a real training image set having a plurality of annotated object instances; and
applying the object detection model on the plurality of target images to detect the one or more object instances and generate corresponding annotations.

2. The method of claim 1, wherein:
the synthetic training image set and the real training image set are aerial images of a road surface;
the one or more object instances are road damages in the road surface, including cracks and/or potholes; and
the object detection model is a self-supervised YOLOv7-based (You Only Look Once version 7 based) deep learning model.

3. The method of claim 1, wherein pre-training the object detection model comprises generating the synthetic training image set by:
extracting a plurality of object instances from a training image set to form a plurality of foreground images;
augmenting the foreground images to generate a plurality of augmented foreground images;
superimposing the plurality of augmented foreground images on a plurality of background images to obtain a superimposed image set; and
processing the superimposed image set to obtain the synthetic training image set having one or more annotations for the object instances.

4. The method of claim 3, further comprising:
augmenting the foreground images by performing at least one of a resizing action, a cropping action, a reorienting action and a blurring action of the foreground images.

5. The method of claim 3, wherein processing the superimposed image set comprises smoothing and reducing a contrast between the plurality of augmented foreground images and the plurality of background images using a Contrast Limited Adaptive Histogram Equalization (CLAHE) technique.

6. The method of claim 1, wherein pre-training the object detection model comprises:
computing the contrastive loss over the synthetic training image set to bring a plurality of embeddings of the object instances of a same class closer together and to push apart embeddings of the object instances of different classes; and
updating the object detection model by adjusting a plurality of model parameters based on an aggregate loss comprising the contrastive loss and a standard detection loss of the object detection model.

7. The method of claim 6, wherein the standard detection loss of the object detection model comprises a combined classification loss, a regression loss and an objectness loss.

8. The method of claim 1, further comprising evaluating a detection performance of the object detection model on a validation image set using precision, recall, and mean average precision metrics.

9. The method of claim 1, further comprising:
deploying the object detection model on an unmanned aerial vehicle (UAV) to perform road crack detection.

10. The method of claim 9, wherein the object detection model is a self-supervised YOLOv7-based deep learning model, and the self-supervised YOLOv7 based deep learning model achieves at least an 8% increase in mean average precision relative to a baseline YOLOv7 based deep learning model trained without the contrastive loss pre-training.

11. The method of claim 1, wherein pre-training and fine-tuning of the object detection model are performed based on an instance localization self-supervised learning (InsLoc) technique.

12. A system for detecting one or more object instances in a plurality of target images, comprising:
a processor configured to:
pre-train an object detection model on a synthetic training image set with a contrastive loss;
fine-tune the pre-trained object detection model on a real training image set having a plurality of annotated object instances; and
apply the object detection model on the plurality of target images to detect the one or more object instances and generate corresponding annotations.

13. The system of claim 12, wherein:
the synthetic training image set and the real training image set are aerial images of a road surface;
the one or more object instances are road damages in the road surface, including cracks and/or potholes; and
the object detection model is a self-supervised YOLOv7-based deep learning model.

14. The system of claim 12, wherein the processor is further configured to:
extract a plurality of object instances from a training image set to form a plurality of foreground images;
augment the foreground images to generate a plurality of augmented foreground images;
superimpose the plurality of augmented foreground images on a plurality of background images to obtain a superimposed image set; and
process the superimposed image set to obtain the synthetic training image set having one or more annotations for the object instances.

15. The system of claim 12, wherein the processor pre-trains the object detection model to:
compute the contrastive loss over the synthetic training image set to bring a plurality of embeddings of the object instances of a same class closer together and to push apart embeddings of the object instances of different classes; and
update the object detection model by adjusting a plurality of model parameters based on an aggregate loss, which comprises the contrastive loss and a standard detection loss of the object detection model.

16. The system of claim 12, wherein the self-supervised YOLOv7-based deep learning model and the self-supervised YOLOv7 based deep learning model achieves at least an 8% increase in mean average precision relative to a baseline YOLOv7 based deep learning model trained without the contrastive loss pre-training.

17. The system of claim 12, wherein the processor is configured to pre-train and fine-tune the object detection model based on an instance localization self-supervised learning (InsLoc) technique.

18. A non-transitory computer-readable medium storing program instructions that, when executed by processing circuitry, performs a method comprising:
pre-training an object detection model on a synthetic training image set with a contrastive loss;
fine-tuning the pre-trained object detection model on a real training image set having a plurality of annotated object instances; and
applying the fine-tuned object detection model on a plurality of target images to detect the one or more object instances and generate corresponding annotations.

19. The non-transitory computer-readable medium of claim 18, wherein:
the synthetic training image set and the real training image set are aerial images of a road surface;
the one or more object instances are road damages in the road surface, including cracks and/or potholes; and
the object detection model is a self-supervised YOLOv7-based deep learning model.

20. The non-transitory computer-readable medium of claim 18, wherein the program instructions comprise instructions to:
extract a plurality of object instances from a training image set to form a plurality of foreground images;
augment the foreground images to generate a plurality of augmented foreground images;
superimpose the plurality of augmented foreground images on a plurality of background images to obtain a superimposed image set; and
process the superimposed image set to obtain the synthetic training image set having one or more annotations for the object instances.
